(19) United States
(12) Patent Application Publication
(10) Pub. No.: US 2002/0144585 A1
(43) Pub. Date: Oct. 10, 2002

(54) Banjo tailpiece

(76) Inventor: Denis G. Potter, Kelowna (CA)

Correspondence Address: ANTONY C. EDWARDS, SUITE 800, 1708 DOLPHIN AVENUE, KELOWNA, BC, V1Y 9S4, CA

(21) Appl. No.: 10/107,072

(22) Filed: Mar. 28, 2002

Related U.S. Application Data
(60) Provisional application No. 60/281,397, filed on Apr. 5, 2001.

(51) Int. Cl. G10D 3/12

(52) U.S. Cl. 84/300

(57) ABSTRACT

A banjo tailpiece includes a rigid one-piece ‘L’-shaped member having a substantially planar first member generally orthogonal and formed as contiguous to a substantially planar second member, the first and second members forming substantially an ‘L’-shape in cross section along a longitudinal axis of symmetry of the ‘L’-shaped member. The first and second members each have opposite first and second ends. The first end of the first member may be substantially the width of a banjo bridge and is adapted for releasable mounting to the first end of the first member of the ends of a laterally spaced apart array of substantially parallel banjo strings. The second end of the first member abuts the first end of the second member so as to form a contiguous, rigid, substantially linear joint joining the first and second members. The joint fits over the rim of the banjo when the tailpiece is mounted to the banjo.

### CROSS REFERENCE TO RELATED APPLICATION

This application claims priority from U.S. Provisional Patent Application No. 60/281,397 filed Apr. 5, 2001 entitled Banjo Tailpiece.

### FIELD OF THE INVENTION

This invention relates to a tailpiece which anchors a plurality of strings across the head of a banjo in longitudinal alignment with the bridge and neck.

### BACKGROUND OF THE INVENTION

The current style of banjo tailpiece includes three pieces. A first and a second leg are hinged generally at right angles to each other. The first leg is mounted to the banjo vertically oriented at the side of the banjo body opposite to and in longitudinal alignment with the neck of the banjo. The second leg of the banjo tailpiece is ‘L’ shaped so as to overlap the first vertically oriented leg and extend inwardly of the perimeter of the body toward the neck of the banjo. An adjusting knob threaded into the overlapping portion of the second leg allows for angular adjustment of the second leg relative to the first leg. The distal edge of the second leg may have guide slots or holes or various other types of openings or notches through or behind which the banjo strings are threaded. Slotted string retaining pins are mounted on the back of the second leg. Loop or ball-end strings are secured to the string retaining pins and passed through the holes or slots at the distal edge of the second leg for extension toward the neck of the banjo.

Most banjo tailpieces have the distal edge of the second leg substantially narrower than the bridge resulting in lateral tension being placed on both strings and bridge where they contact. Should a string break during a performance, such lateral tension often results in pivotal rotation of the tailpiece at the point of attachment with the banjo body, resulting in the instrument becoming out-of-tune.

Further, the design of such tailpieces has been found to impose some difficulty for a player when attempting to rapidly replace a broken string during a performance.

Also, the tension of the strings as they pass from under the tailpiece and over the bridge impose vertical and horizontal forces on the tailpiece which result in inherent instability of the tailpiece. This instability causes difficulty in tuning the banjo and maintaining the banjo in tune.

In the prior art, the applicant is aware of U.S. Pat. No. 6,107,553 which reveals a unitarily constructed banjo tailpiece having a string hook attachment member and a string guide member. The string hook attachment member is fastened to the vertical side wall of the banjo body and the string guide member is positioned inwardly of the banjo head.

### SUMMARY OF THE INVENTION

It is therefore an object of the present invention to provide a sturdy, unitary banjo tailpiece having a vertical leg adapted to fit snugly against a side of the banjo body between adjacent hold-down hooks opposite to and in longitudinal alignment with the neck of the banjo. The vertical leg is formed with an outwardly projecting connecting tab, at one end, suitably apertured, through which a connecting bolt may be passed for securing and adjusting the tailpiece to the body of the banjo and for allowing vertical angular adjustment of the tailpiece.

A horizontal leg is formed integrally with the vertical leg, at the end opposite to the connecting tab, and is positioned at an acute angle to the vertical leg so as to extend inwardly of the perimeter of the body toward the neck of the banjo. The distal edge of the horizontal leg has a plurality of slotted guide holes through which the banjo strings are threaded permitting the strings to protrude from under the bottom of the distal end of the second leg towards the bridge. Adjacent to the guide holes are retaining posts to which loop-end banjo strings may be attached.

The interior surface of the horizontal leg may be positioned in contact with the upper surface of the banjo tension ring. The angle of the horizontal leg in relation to the upper surface of the banjo may be modified by adjusting the connecting bolt.

Further, it is a feature in one embodiment of the present invention to provide a banjo tailpiece of a sturdy unitary construction which has a distal end of sufficient width to allow string guide holes to be placed in substantially coaxial alignment with string retaining grooves in the bridge of the banjo to thereby reduce lateral forces transmitted from the grooves to the tailpiece.

Further, it is an object of the present invention to provide, through material selection, a banjo tailpiece which resists upward deflection due to string tension and which may be adjusted so as to maintain an optimum string angle of 15° between the underside of the tailpiece and the bridge.

In summary, the banjo tailpiece of the present invention includes a rigid one-piece ‘L’-shaped member having a substantially planar first member generally orthogonal and formed as contiguous to a substantially planar second member, the first and second members forming substantially an ‘L’-shape in cross section along a longitudinal axis of symmetry of the ‘L’-shaped member. The first and second members each have opposite first and second ends. The first end of the first member may be substantially the width of a banjo bridge and is adapted for releasable mounting to the first end of the first member of the ends of a laterally spaced apart array of substantially parallel banjo strings. The second end of the first member abuts the first end of the second member so as to form a contiguous, rigid, substantially linear joint joining the first and second members. The joint for fits over the rim of the banjo when the tailpiece is mounted to the banjo.

A cantilevered flange extends rigidly from the second end of the second member so as to be oppositely disposed relative to the first member and generally parallel thereto. The flange has an aperture therein for receiving a bolt therethrough for adjustably mounting the tailpiece to the banjo.

The first and second members form an acute included angle such that, when the tailpiece is mounted to the rim of the banjo so as to align the longitudinal axis of symmetry of the tailpiece parallel with the banjo strings and the grooves in the banjo bridge, an angle of substantially 15° is formed between the strings extending from the first end of the first member to the bridge and a plane containing the first member.

In an alternative embodiment, the joint further comprises a strengthening stiffener extending from opposite sides of the joint parallel to the axis of symmetry. The tailpiece may also include a pair of rigid protrusions on the second member and disposed equidistant on opposite sides of the axis of symmetry. The protrusions extend from the second member on the same side of the second member as the first member so as to stabilize the tailpiece against the rim of the banjo. The protrusions may be formed by dimples in the second member adjacent the joint. The tailpiece stiffener may be a single bulge formed across the joint, and lying along the axis of symmetry, so as to distend an upper surface of the first member and an outer surface of the second member. The bulge may be symmetric across the joint. Alternatively, the stiffener may include a pair of creases formed in and across the joint, each crease of the pair of creases parallel to the axis of symmetry and symmetry disposed on opposite sides of the axis of symmetry.

The first end of the first member includes a laterally spaced apart array of holes parallel to a distal edge of the first end. Each hole in the array of holes may have an offset slot, offset from parallel to the axis of symmetry, forming a string-passing passageway from the hole to an edge of the first end of the first member. An array of posts, for mounting looped string-ends thereto, may be mounted on an upper surface of the first member in a laterally spaced apart array of posts parallel and adjacent to the array of holes.

In one embodiment the first and second members are plates. The first member may be alternatively characterized as being generally a rectangular parallelepiped, flared at its first end. The second member may be characterized as being generally a triangular right prism, where the vertex of the triangular right prism is folded to form the flange. The base of the triangular right prism is co-extensive with the second end of the first member.

### BRIEF DESCRIPTION OF THE DRAWINGS

FIG. 1 is a perspective view of the tailpiece of the present invention mounted on a banjo.

FIG. 2 is an enlarged perspective view of the tailpiece of FIG. 1.

FIG. 3 is an enlarged portion of FIG. 2.

FIG. 4 is a sectional view taken on line 4-4 of FIG. 3.

FIG. 5 is a sectional view taken on line 5-5 of FIG. 1.

FIG. 6 is a partially cut-away plan view of the tailpiece of FIG. 1.

FIG. 7 is the portion of the tailpiece of FIG. 3 showing loop end and ball end strings mounted thereto.

FIG. 8 is, in partially cut-away perspective view, an alternative embodiment of the present invention incorporating stabilizers for stabilizing the tailpiece against the rim of a banjo.

FIG. 9 is a sectional view along line 9-9 in FIG. 8.

FIG. 10 is a sectional view along line 10-10 in FIG. 8.

FIG. 11 is in perspective view, a further alternative embodiment of the tailpiece of the present invention having an outwardly projecting bend strengthening deformation.

FIG. 12 is a sectional view taken on line 12-12 of FIG. 11.

FIG. 13 is a sectional view taken on line 13-13 of FIG. 11.

FIG. 14 is a perspective view of a further alternative embodiment of the tailpiece of the present invention having parallel inwardly projecting bend strengthening deformations.

FIG. 15 is a sectional view taken on line 15-15 of FIG. 14.

FIG. 16 is a partially cut away side elevational view of the tailpiece of FIG. 14.

### DETAILED DESCRIPTION OF EMBODIMENTS OF THE INVENTION

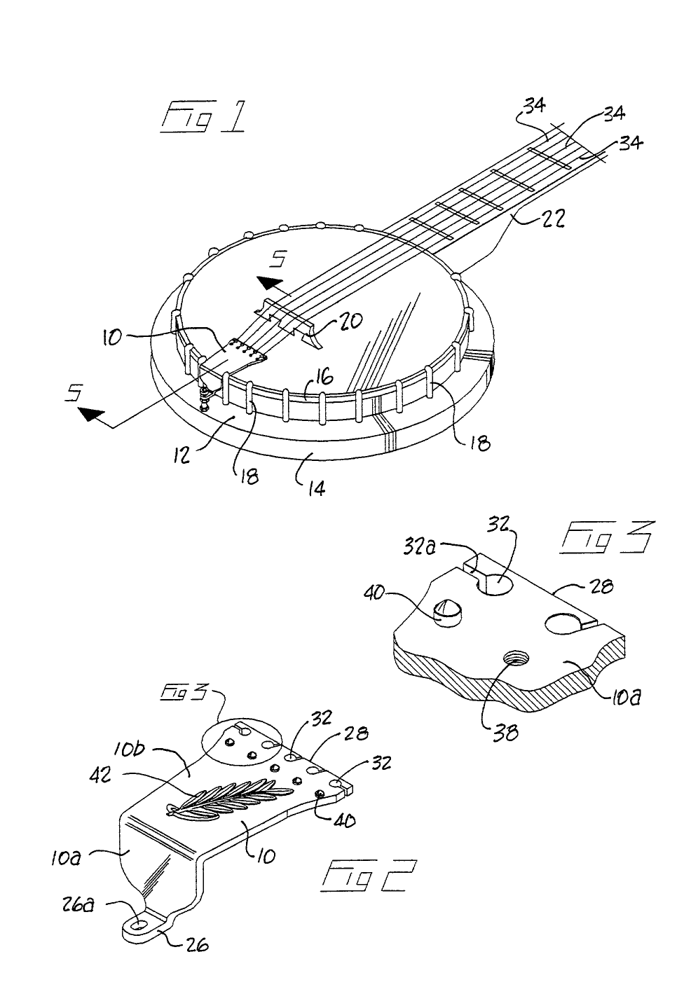

With reference to the accompanying drawing figures, wherein similar reference characters denote corresponding parts in each view, as seen in FIG. 1 a tailpiece 10 according to the present invention is secured to a perimeter flange 12 on the body 14 of a banjo. Tailpiece 10 is positioned over the tension ring 16 of the banjo between adjacent hold-down hooks 18, opposite to and in longitudinal alignment with the bridge 20 and neck 22 of the banjo.

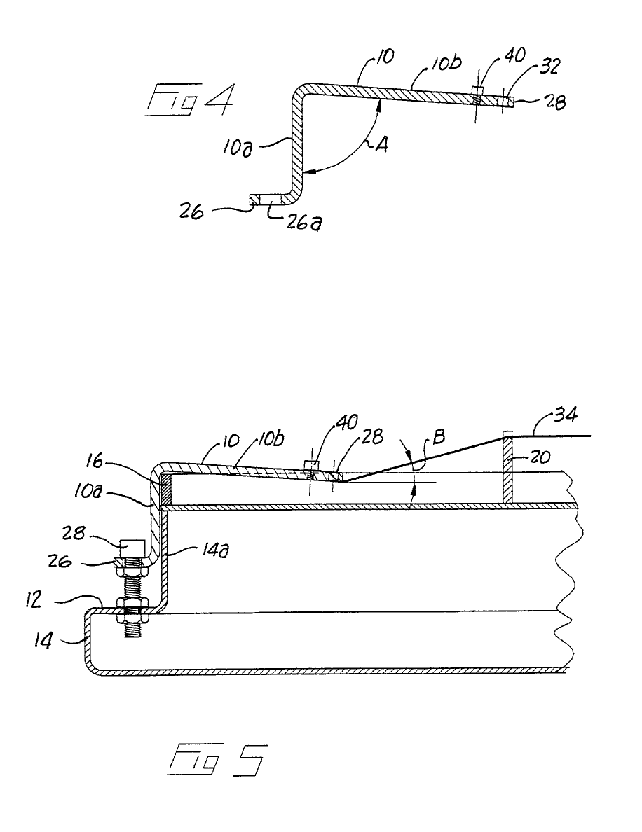

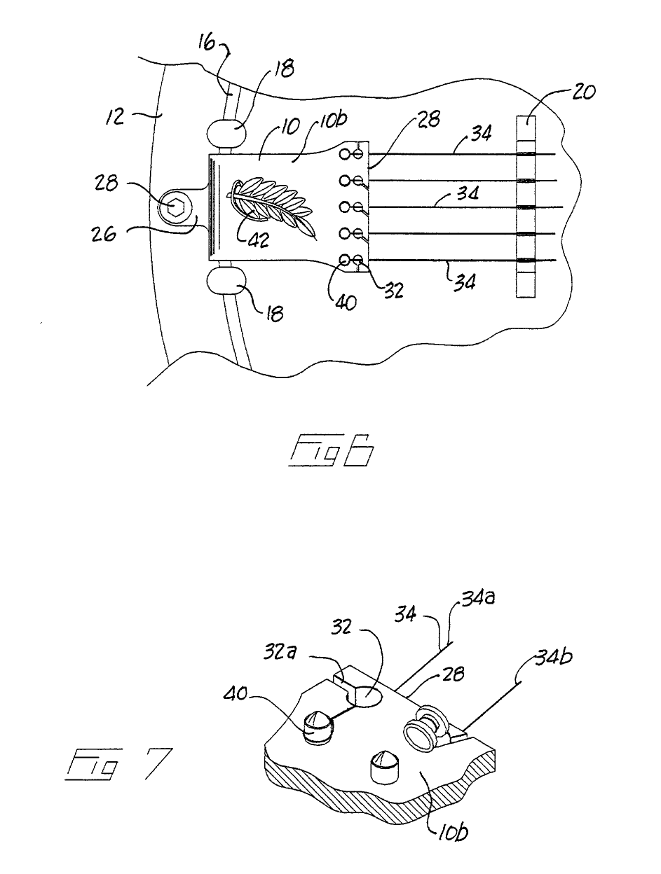

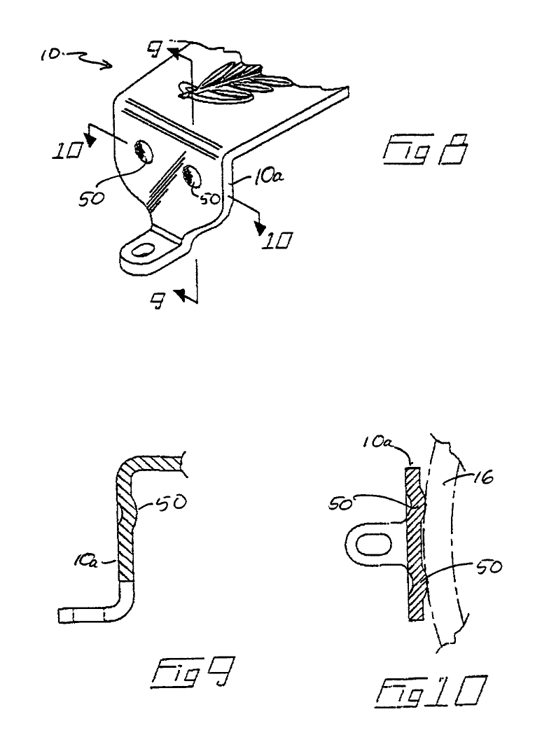

Banjo tailpiece 10 is of unitary construction, and, for example, manufactured from 10 gauge stainless steel or similar material bent to form generally vertical and horizontal legs 10a and 10b respectively as better seen in FIG. 2. Reference to vertical and horizontal legs is for ease of reference when viewing the banjo of Figure, that is which is laid flat on its back, and is thus not intended to be limiting. Included angle A between legs 10a and 10b may, as seen in FIG. 4, be in one embodiment 86°. As seen in FIG. 5, leg 10a fits snugly against a side 14a of banjo body 14. An outwardly projecting connecting tab 26 projects from one end of leg 10a and is bent generally at right angles thereto. Tab 26 has an elongated slot 26a for adjustment of bolt 28 therethrough. Connecting bolt 28 secures tailpiece 10 to perimeter flange 12 on body 14.

Leg 10b has a distal edge 28 generally matching or corresponding to the width of bridge 20. As seen in FIG. 3, a plurality of slotted guide holes 32 are formed near or adjacent distal edge 28, each to accept therein and retain an end of a banjo string 34. When the tailpiece is mounted on the banjo, guide holes 32 fall on the longitudinal axes of their corresponding strings 34, in substantially coaxial alignment with the corresponding string retaining grooves formed in bridge 20. Immediately adjacent guide holes 32, and also coaxial with the bridge grooves, are an array of threaded holes 38 into which string retaining posts 40 are rigidly mounted. Posts 40 may either be plain metal posts or may be decorated posts within which are set synthetic gem stones or the like. Thus, as seen in FIGS. 5 and 6, strings 34 are in substantially parallel alignment across bridge 20 as they extend to guide holes 32 within tailpiece 10. The breakage of one or more strings while playing the instrument may thus not result in a sufficient rotational moment to cause the tailpiece to rotate. Thus breakage of one or more strings will not substantially affect the tuning of the remaining strings.

Two common types of banjo strings are illustrated in FIG. 7. String 34a has a loop end. String 34b has a ball end. Loop end string 34a may be easily inserted into a guide hole 32 by passing it through slot 32a and placing the loop end over a corresponding string retaining post 40. Ball end string 34b need only be placed within a guide hole 32 by passing it through slot 32a. The size of the ball end and the tension exerted on the string once it is tuned prevents loosening of the string. Releasing a broken string from the tailpiece and replacement of same during a performance is therefore simplified.

Connecting bolt 28 permits vertical adjustment of tailpiece 10 to compensate for minor dimensional differences in instruments. It also enables compensation for any upward deflection of tailpiece 10 resulting from string tension thus enabling maintaining angle B at the optimum string angle of 15° as measured between the plane of the underside of tailpiece 10 and the string extending to bridge 20.

Since the string retaining posts 40 are positioned near distal edge 28 of leg 10b, the upper surface may be adorned with for example a decorative motif 42 or an appropriate trade mark which may be flat or elevated on the exposed surface without affecting the function of the tailpiece. In the present invention the aesthetics of the tailpiece are thus improved over the prior art. The tailpiece has cleaner lines, reduced protrusions, and allows for significant adornment by gem stones and the like resulting in a piece of functional jewellery.

As seen in FIGS. 8-10, tailpiece stabilizers, for example, in the form of indentations, bumps, raised lands or detents 50 are formed on leg 10a so as to project inwardly to rest against tension ring 16. Detents 50 are formed equidistant on either side of the vertical center line of leg 10a, that is, equidistantly laterally spaced on either side of the axis of symmetry of tailpiece 10 so as to bear equally against tension ring 16. Without the use of such stabilizers, tailpiece 10 only contacts ring 16 on the axis of symmetry of the tailpiece due to the fact that leg 10a is planar and ring 16 is arcuate. Detents 50 may be formed by punching the front face of leg 10a during formation of tailpiece 10.

In manufacturing tailpiece 10, an elongate metal blank may be employed ranging in length from 4 ⅛ inches to 4 ⅝ inches long in order to suit the most common sizes of banjos. The blank may be 2 1/16 inches wide at one end and taper substantially toward the other end. The blank is bent to form the interior angle between the first and second leg of 86°. The vertical leg, which is shorter in length than the horizontal leg, is tapered and has an elongated hole formed near its extremity. A right angle bending of the extremity of the vertical leg, in a direction opposite to that of the horizontal leg creates the connecting tab.

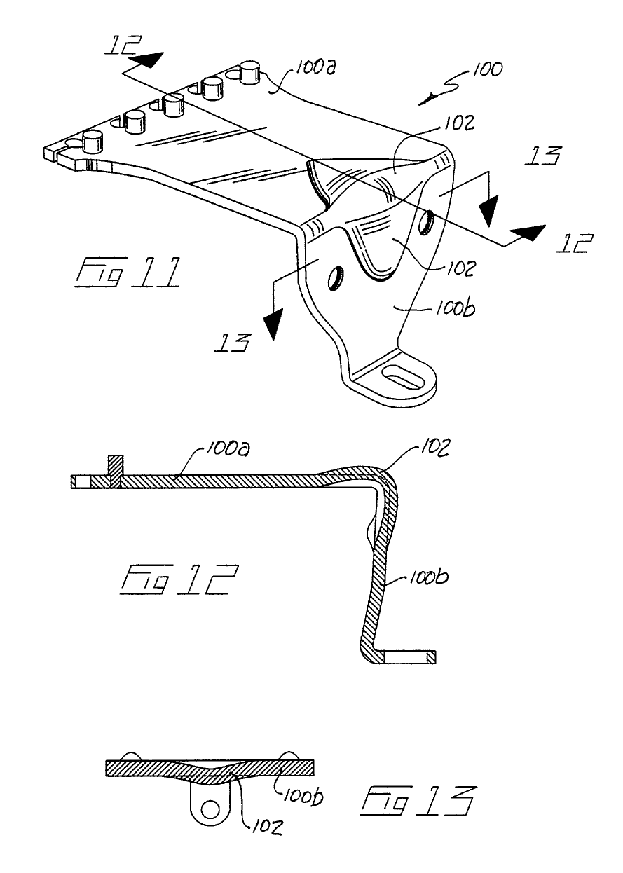

With reference to FIGS. 11 through 13, in a further alternative embodiment, banjo tailpiece 100 is formed with an outwardly projecting, stiffening deformation or bulge 102. Such deformations may be formed by the use of a hydraulic press and a die to effect a uniformly shaped deformation while maintaining a uniform wall thickness. Deformation 102 extends symmetrically along the longitudinal centreline and axis of symmetry as indicated by line 12-12, and equidistantly along both the horizontal and vertical legs 100a and 100b respectively. Deformation 102 resists the effect of string tension on the underside of leg 100a where such tension would tend to urge the distal end of leg 100a upwardly thereby increasing angle A′ as seen in FIG. 16 and thus reducing the optimum 15° string angle as seen in FIG. 5 between the tailpiece and the bridge.

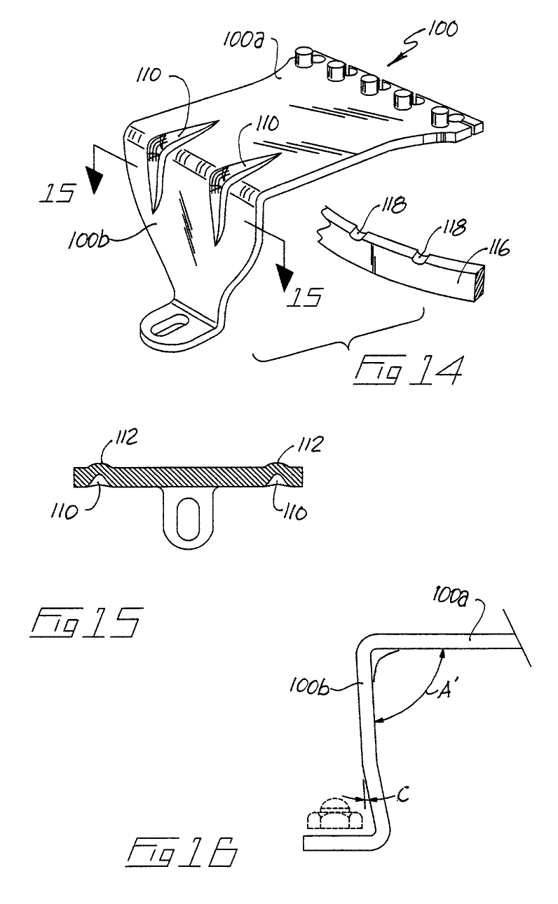

An alternative stiffening deformation 110 is shown in FIGS. 14 and 15. Deformation 110 may again be formed by the use of a hydraulic press and a die to effect a uniformly shaped deformation while maintaining a uniform wall thickness. Deformations 1 10 are in the form of a pair of knee recesses extending equidistantly along both the horizontal and vertical legs 100a and 100b respectively. Deformations 110 project inwardly of the knee or fold joint between legs 100a and 100b to thereby form internal stiffening ribs 112. Ribs 112 may require that the banjo tensioning ring 116 as shown in FIG. 14, be modified by forming recesses 118 to mate with corresponding internal stiffening ribs 112.

The partial side view of the tailpiece 100 as shown in FIG. 16 illustrates that the internal angle A′ between legs 100a and 100b is optimally formed as substantially 85°. In order to accommodate attachment of the tailpiece 100 to the banjo, leg 100b is further slightly bent in a direction toward leg 100a, as shown by angle C, by approximately 10°.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A banjo tailpiece comprising:
a rigid one-piece ‘L’-shaped member having a substantially planar first member generally orthogonal and formed as contiguous to a substantially planar second member, said first and second members forming substantially an ‘L’-shape in cross section along a longitudinal axis of symmetry of said ‘L’-shaped member,
said first member having opposite first and second ends, said second member having opposite first and second ends,
said first end of said first member being substantially the width of a banjo bridge and is adapted for releasable mounting to said first end of said first member of the ends of a laterally spaced apart array of substantially parallel banjo strings,
said second end of said first member abutting said first end of said second member so as to form a contiguous, rigid, substantially linear joint joining said first and second members, said joint for fitting over the rim of the banjo when said tailpiece is mounted to the banjo,
a cantilevered flange extending rigidly from said second end of said second member so as to be oppositely disposed relative to said first member and generally parallel thereto, said flange having an aperture therein for receiving a bolt therethrough for adjustably mounting said tailpiece to the banjo.

2. The tailpiece of claim 1 wherein said first and second members form an included angle of substantially 86°.

3. The tailpiece of claim 1 wherein said first and second members form an acute included angle such that, when said tailpiece is mounted to the rim of the banjo so as to align said longitudinal axis of symmetry parallel with the banjo strings and the grooves in the banjo bridge, an angle of substantially 15° is formed between the strings extending from said first end of said first member to the bridge and a plane containing said first member.

4. The tailpiece of claim 1 wherein said first and second members are plates.

5. The tailpiece of claim 2 wherein said first and second members are plates.

6. The tailpiece of claim 3 wherein said first and second members are plates.

7. The tailpiece of claim 1 wherein said joint further comprises a strengthening stiffener extending from opposite sides of said joint parallel to said axis of symmetry.

8. The tailpiece of claim 1 further comprising a pair of rigid protrusions on said second member and disposed equidistant on opposite sides of said axis of symmetry, said protrusions extending from said second member on the same side of said second member as said first member.

9. The tailpiece of claim 8 wherein said protrusions are formed by dimples in said second member adjacent said joint.

10. The tailpiece of claim 7 wherein said stiffener is a single bulge formed across said joint, and lying along said axis of symmetry, so as to distend an upper surface of said first member and an outer surface of said second member.

11. The tailpiece of claim 10 wherein said bulge is symmetric across said joint.

12. The tailpiece of claim 7 wherein said stiffener includes a pair of creases formed in and across said joint, each crease of said pair of creases parallel to said axis of symmetry and symmetry disposed on opposite sides of said axis of symmetry.

13. The tailpiece of claim 1 wherein said first end of said first member includes a laterally spaced apart array of holes parallel to a distal edge of said first end, each hole in said array of holes having an offset slot, offset from parallel to said axis of symmetry, forming a string-passing passageway from said hole to an edge of said first end of said first member.

14. The tailpiece of claim 13 further comprising an array of posts, for mounting looped string-ends thereto, mounted on an upper surface of said first member in a laterally spaced apart array of posts parallel and adjacent to said array of holes.

15. The tailpiece of claim 1 wherein said first member is generally a rectangular parallelepiped flared at said first end of said first member, and wherein said second member is generally a triangular right prism, a vertex of said triangular right prism folded to form said flange, a base of said triangular right prism co-extensive with said second end of said first member.
